(19) United States
(12) Patent Application Publication
(10) Pub. No.: US 2006/0073886 A1
(43) Pub. Date: Apr. 6, 2006

(54) Gaming device, system, and method having concurrent gaming features

(75) Inventors: Kim Tempest, Henderson, NV (US); Jon Leupp, Henderson, NV (US)

Correspondence Address: BERNHARD KRETEN;WEINTRAUB GENSHLEA CHEDIAK SPROULE, 400 CAPITOL MALL, 11TH FLOOR, SACRAMENTO, CA, 95814, US

(73) Assignee: Aristocrat Technologies Australia Pty Ltd

(21) Appl. No.: 10/956,216

(22) Filed: Oct. 1, 2004

(51) Int. Cl. G06F 19/00

(52) U.S. Cl. 463/27

(57) ABSTRACT

A gaming device having a primary game and at least one concurrent game that is played on the primary game playfield using the outcome of the primary game. The concurrent game or games are separate from the primary game and may pay awards regardless of the outcome of the primary game.

### FIELD OF THE INVENTION

The following invention is generally related to instrumentalities and methodologies in gaming devices. More specifically, the instant invention is directed to a method and apparatus that features a primary game and at least one concurrent game, with both games displayed on the same playfield but each being separate and distinct games or features.

### BACKGROUND OF THE INVENTION

Prior art gaming devices generally feature a primary game having a plurality of reels showing symbols generated in a random fashion. When the reels stop spinning, the resulting orientation of symbols is compared to a paytable and the player is awarded for any matches. Some games extend this idea by allowing awards to be given for orientations other than mere ‘symbols in a row’, bestowing “scatter pay” awards and offering creative payline orientations. Additionally, several devices offer “bonus games” played subsequent to the primary game; often presenting the player with an enhanced opportunity to win larger awards than on the primary game, or merely offering the player an opportunity to play an entirely different game than the primary game, such as a bonus game.

The following prior art reflects the state of the art of which applicant is aware and is included herewith to discharge applicant's acknowledged duty to disclose relevant prior art. It is stipulated, however, that none of these references teach singly nor render obvious when considered in any conceivable combination the nexus of the instant invention as disclosed in greater detail hereinafter and as particularly claimed.

| PATENT NO. | ISSUE DATE | INVENTOR |
|---|---|---|
| 4,856,787 | Aug. 15, 1989 | Itkis |
| AU 770097 | Feb. 12, 2004 | Muir et al. |
| AU 771847 | Apr. 1, 2004 | Bryant et al. |
| AU 738686 | Sep. 27, 2001 | McNee |
| AU 766627 | Oct. 23, 2003 | Bennett |
| AU 774429 | Jun. 24, 2004 | Bennett |
| WO04/004856 | Published: Jan. 15, 2004 | Stevens |

The prior art references listed above teach other devices for wagering. None discloses a gaming device and method having concurrent games using the base display involving, inter alia, an independent target.

### SUMMARY OF THE INVENTION

The present invention is distinguishable over the prior art in that one or more concurrent or feature games are offered in addition to a primary or base game. Reels are enabled for use in the concurrent game through wagering before the primary game commences. The concurrent game may be a game of chance that involves feature indicators that are displayed in the primary game. The special indicators operate in the concurrent game to produce feature game outcomes which can provide awards in addition to any base game award.

### OBJECTS OF THE INVENTION

Accordingly, it is a primary object of the present invention to provide a new and novel device and method for generating interest in play of a gaming device.

It is a further object of the present invention to provide a device and method as characterized above in which the success of a player is not limited to a single gaming proposition.

It is a further object of the present invention to provide a device and method as characterized above which provides a player with concurrent gaming opportunities having differing characteristics.

It is a further object of the present invention to provide a system including a plurality of gaming devices wherein when a feature indicator is selected, a feature outcome is selected and may result in a device based or system based award.

It is a further object of the present invention to provide a device, system and method as characterized above that is simple to understand and to implement.

Viewed from a first vantage point, it is an object of the present invention to provide a method for a player to play an electronic gaming device of the type having a video display, a processor, and a data input device, the method comprising: providing a data structure storing data representing base game indicia and at least one feature game indicia. The player makes a wager to play the device and initiate play. The processor in response to initiation of play randomly selects data from the data structure and displays the selected data as indicia or one or more indicator(s) at the video display to define at least one base game outcome. If the base game outcome defines one of a predetermined schedule of winning base game outcomes, a base game award is issued to the player. If the feature indicator is selected and displayed, the processor is configured to select a feature outcome corresponding to an outcome for a separate feature, e.g. concurrent, game.

Viewed from a second vantage point, it is an object of the present invention to provide a gaming device, comprising, in combination: a display; wagering means; a processor controlling an electronic display and apparatus for the player to input a wager. Upon receipt of a wager and prompting of play, processor selects and controls the display to display a base game output, the outputs formed from a plurality of symbols defining base game indicia and one or more feature indicators such as special symbols, background, marker or other visual indication that the player has obtained a feature indicator. The base game indicia and combinations thereof are compared to a predetermined paytable and if a winning outcome has been obtained the player is issued a base game award. If one or more feature symbols are selected and displayed the player is entitled to have selected as a result thereof a feature outcome such as, for example, the random selection of a concurrent game outcome, chance at a prize, Keno or Bingo play or lottery selection or the like. In one embodiment the concurrent game relates to regions of the display, each region having a target symbol, the target symbol defining a winning feature outcome corresponding to its respective region. Based upon, for example, the wager made by the player, regions for play are activated or enabled. When a feature indicator is selected and displayed in association with an activated region, a concurrent game outcome is selected and if the selected symbol compares to the target symbol, a feature award is issued to the player.

Viewed from a third vantage point, it is an object of the present invention to provide a method of gaming, the steps including: displaying a R×C array formed from plural regions each having plural symbols; enabling at least one region to act in operative concert with the R×C array; establishing a target outcome associated with each enabled region; playing a game wherein the symbols are rearranged in the R×C array; comparing the rearranged array with a paytable for potential awards upon matching the paytable with the rearranged array; and comparing at least one output with the target in the enabled region.

These and other objects will be made manifest when considering the following detailed specification when taken in conjunction with the appended drawing figures.

### BRIEF DESCRIPTION OF THE DRAWINGS

FIG. 1 is a flowchart of the methodology according to the present invention.

FIG. 2 is a depiction of the apparatus associated therewith.

FIG. 3 is a depiction of the game playfield having all reels enabled in the concurrent game.

FIG. 4 is a depiction of the game playfield having only one reel enabled in the concurrent game.

FIG. 5 is an illustration of a system according to an embodiment of the present invention.

### DESCRIPTION OF PREFERRED EMBODIMENTS

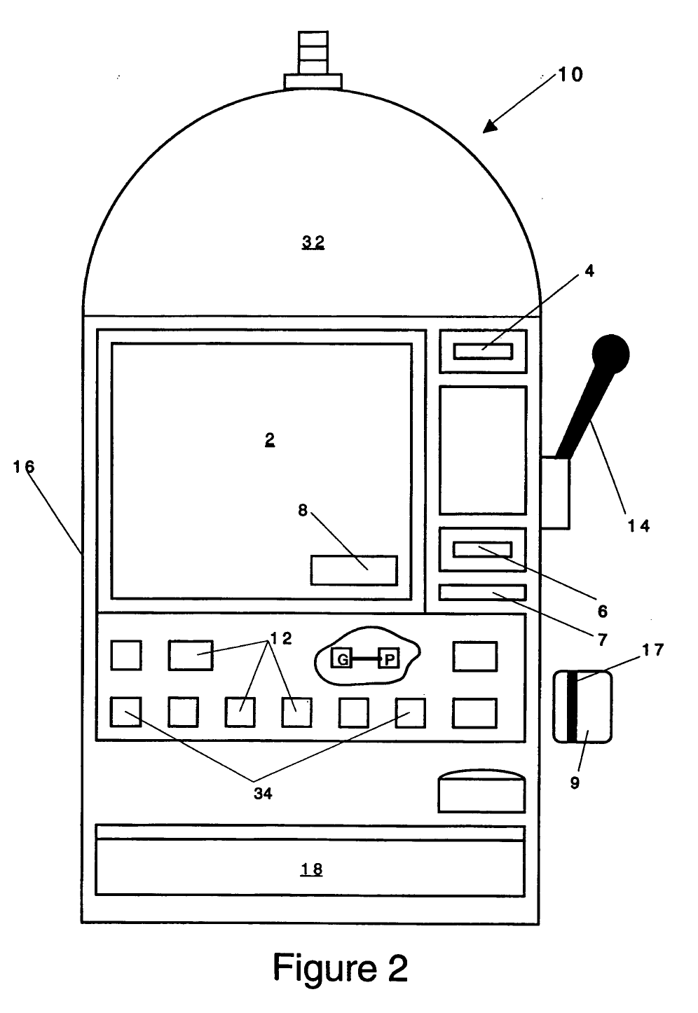

Considering the drawings, wherein like reference numerals denote like parts throughout the various drawing figures, reference numeral 10 as shown in FIG. 2 is directed to the device according to the present invention.

In its essence, the device 10 includes a housing 16 which supports a visual display 2, preferably a video monitor, therewithin. The display 2 may include a window 8 for special messages or for incrementing counting of credits accumulated by the player. The device also includes an LED or other readout 4 for prompting the player and can provide similar verbiage as the window 8 or in lieu thereof, to stimulate the player. The device includes an inlet 6 for the reception therein for coins, currency or the like to auger in the inception of play. A plurality of decision-making buttons 12 are located on the face of the apparatus 10, preferable below the display 2, and a pull handle 14 can be used to initiate play as an alternative to supplement the decision-making buttons 12. A coin hopper 18 or other payment methods, i.e., ticket printers, may be included to effectuate an output of an award due the player. The device 10 may have a top portion 32 with a display thereon having a motif correlative with the game to be played and can include a paytable. A plurality of speakers 34 may be included on the device for aural interaction with the player. The apparatus also includes a processor P coordinating all functions and a random number generator G operatively coupled thereto for generating outcomes. A card 9, having a read/write instrumentality 17 thereon, can be read via input 7 as a substitute for or supplement to credit transfers as well as player identification.

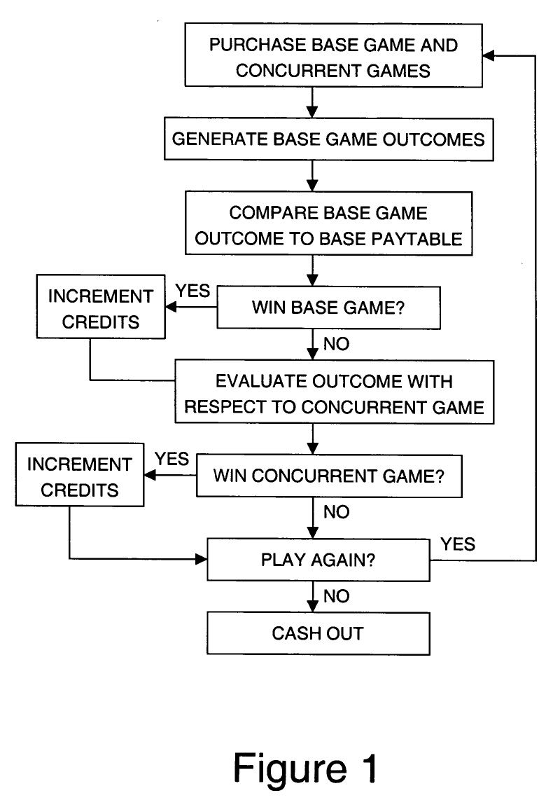

Referring to FIG. 1, the flow chart associated with the present invention can be explored. The device 10 is enabled when a player deposits a wager. The features of the present invention are preferentially operative upon the deposit of a maximum wager. Assume a maximum wager is deposited. A primary game (base game) appears for play on the display 2. The primary game may be of any type, but is preferably a reel type game. The primary game outcome is compared to a paytable and the player is awarded credits for any matching outcomes.

The concurrent game or games (also referred to herein as feature games) are played in association with, and in certain embodiments on, the same base game displayed playfield; that is, with the same display from the primary reel game. Each reel 50a-50e may be separately enabled for use in the concurrent game or games. Should a non-reel game be used as the base or primary game, the playfield can be broken up into “regions” that behave as the reels 50a-50e do according to this embodiment. Thus, each reel 50a-50e is a “region” in a reel type game. Other regions could be defined for the game display matrix such as by being associated with each or a selected some of the base game pay lines, rows, quadrants or the like.

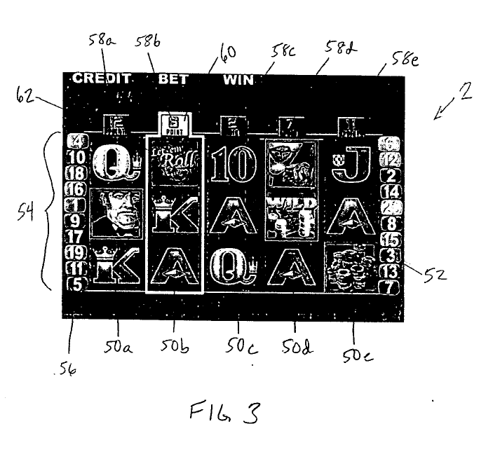

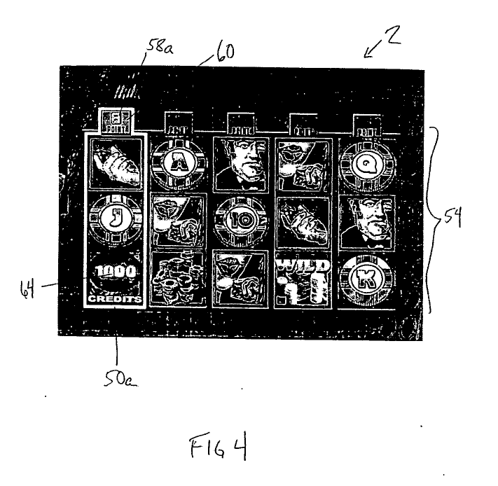

The manner in which concurrent games are enabled is preferentially dependent on the amount of the initial wager. For example, FIG. 3 shows a standard 5-reel, 20-payline game, in which a player may choose to play one, five, ten, fifteen, or twenty paylines 52. The 5-reels display defines a 3-row, 5-column (3×5) R×C array 54. If the player chooses to play one payline 52, the concurrent game with respect to the first reel 50a is enabled, as in FIG. 4. If the player chooses to play five, ten, fifteen, or twenty paylines 52, the concurrent games with respect to the second, third, fourth and fifth reels 50b-50e, respectively, are enabled in addition to that of the first reel 50a. It is also within the scope of the present invention to associate one concurrent game per payline.

In a further embodiment one or more wagers in addition to any base game wager, are required to, in essence, buy-up or enable, concurrent game(s) features.

The concurrent game may be of any suitably adapted game of chance, including, but not limited to: card games, such as blackjack, baccarat, or poker; variations of craps or other dice games; lotteries; other casino games of chance, such as roulette or keno; and other non-casino games of chance, such as “finger games” (e.g., ‘odd/even’, ‘rock, paper, scissors’, etc.). The embodiment described hereinbelow uses a variation of the game of craps as its concurrent game. It is also within the scope of the present invention to provide a concurrent game which is not chance dependent, such as conventional “Indian casino” slot machines (e.g., Class II gaming).

When the wager is made, the appropriate reels 50a-50e are enabled. FIG. 3 shows a playfield in which all 20 paylines 52 are played, the paylines 52 indicated along the vertical margins 56 of the array 54, and all five reels 50a-50e are enabled. FIG. 4 shows a playfield in which only the first reel 50a is enabled. Each enabled reel 50a-50e shows a target value 58a-58e, also called a winning feature outcome or “point”, preferably in a graphical box 60 located above or otherwise adjacent the reel 50a-50e. Alternatively, point values 58a-58e for all reels 50a-50e could be displayed on a table in another portion of the display 2, separate from the reels 50a-50e. The “point” 58a-58e displayed on each reel 50a-50e is preferably determined independently of that displayed on the other reels. Alternatively, the point values on enabled reels could be related by an algorithm. Where a point value has not been established for a concurrent game, the game processor selects a default value, e.g. “7”.

The primary (base) game outcome is displayed and the player is awarded according to the primary game paytable, if appropriate in a manner as known in the prior art. Base game awards may be in the form of line pay awards (winning symbol combinations on wagered upon pay lines, scatter pays or the like. Success in the concurrent game is determined by the occurrence or non-occurrence of a special indicator or symbol 62, such as a picture of a pair of dice, on enabled regions as, in this embodiment, defined by reels 50a-50e. In a preferred embodiment, if the special indicator 62 occurs on an enabled reel, the dice animate to produce a value. The value displayed on the dice (feature outcome) is compared to the predetermined (or default) point value 58a-58e on the enabled reel 50a-50e on which the dice are displayed, and the player is awarded for matching the point value 58a-58e. The animated dice may then be replaced by an award animation 64, for example, showing the amount awarded the player as in FIG. 4.

The algorithm for selecting the point value 58a-58e preferably begins by assigning a default point value of seven. Alternatively, the beginning point value may be randomly selected when each reel 50a-50e is enabled.

If the point is seven and the dice show a seven, the player is awarded. If the point is seven and the dice show anything other than a seven, the point for the enabled region, changes to the value shown on the dice, with the graphical box 60 or table being updated with the new point value.

If the point is something other than a seven and the dice roll matches the point, the player is awarded and the point changes back to a seven. If the point is something other than a seven and the dice roll is a seven, the point changes back to a seven and no award is paid. If the point if something other than a seven and a value is shown that is neither a seven or the point, the point does not change and no award is paid.

The amount of the award paid is preferably tied to the statistical probability of values in the dice roll, e.g., results of two and twelve are least statistically likely to occur and therefore pay higher than other values. That is, if the point is “4” and the feature indicator results in a matching outcome of “4” the player is paid an award reflecting the 2:1 probability of obtaining a “4” versus a “7” (3 ways to roll a “4” versus six ways to roll a “7”) Alternatively, the award values could be equal, if the concurrent game chosen lends itself to various equal probability results.

The preferred embodiment is described with reference to a primary reel game, but could easily be implemented in other types of games, such as video poker or other matrix-type games. Any game that lends itself to the concept of “enablement”, as described herein, is suitable for use as a primary game. Similarly, any game of chance that may be structured as a simple comparison may be used as the concurrent game.

Further, the invention is not limited to use of simple comparisons in the concurrent game. The combination of values on enabled reels 50a-50e could be used to provide a more complex concurrent game, such as a game that uses two enabled reels 50a-50e to set boundary values for the winning feature outcome 58a-58e, with the feature indicator 62 providing a means for generating or displaying a value (feature outcome) for comparison to the boundary values.

In addition to the enablement of reels 50a-50e based on the initial wager, the player may instead be offered the option of “purchasing” feature, e.g. concurrent, games. Such a choice may be offered in addition to the decisions about paylines 52, or if a game offers only fixed paylines 52, the player could be offered the opportunity to enable reels 50a-50e. Another embodiment contemplates the player choosing which reels 50a-50e to enable, as opposed to following a default decision path in the device without player choice.

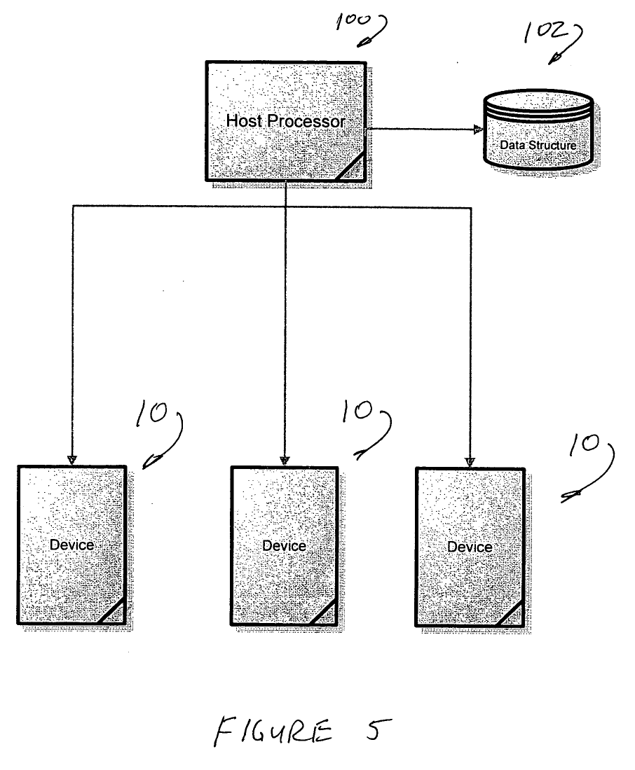

Turning to FIG. 5, a system application of the present invention is illustrated. According to this embodiment, each gaming device 10 is linked via electronic communication means to a host processor 100. In one embodiment, the host processor 100 operates to download and control the operation for each individual device 10 to select base game outcomes as well as any feature indicators defining a central determination arrangement. In another embodiment, each device 10 includes its own game control processor of the type described above for selecting and displaying base game outcomes. In either arrangement, the host processor 100 includes a jackpot database 102 which, in association with the host processor 100, provides for the selection of one or more jackpot outcomes. In but one example, the host processor 100 and database may cooperate to randomly select, from a field of numbers 1-1,000,000, a specific number, e.g. 799. Upon a device selecting and displaying a feature indicator, one of the base game processor or host processor 100 selects a number between 1 and 1,000,000. The number could be selected randomly. If the number selected as a result of the selection of the feature indicator matches the jackpot outcome number, the player wins a jackpot. Otherwise the player wins nothing, a minor award of a consolation prize.

In other embodiments, the feature indicator may result in a Bingo play, Keno play, or the like.

The feature indicator, as described above, may be a symbol which is displayed in the base game display. The symbol, when selected, can be treated as a wild symbol, multiplier symbol, or the feature symbol as described above. That is, upon selection of the feature symbol, its attribute of being wild, a pay line multiplier, an outcome multiplier of driving the selection for the concurrent (feature) game is also selected and applied.

Moreover, having thus described the invention, it should be apparent that numerous structural modifications and adaptations may be resorted to without departing from the scope and fair meaning of the instant invention as set forth hereinabove and as described hereinbelow by the claims.

I claim:

1- A method for a player to play an electronic gaming device of the type having a video display, a processor, and a data input device, the method comprising:
providing a data structure storing data representing base game indicia and data representing at least one feature indicator;
the player making a wager to play the device and initiate play, said processor in response to initiation of play randomly selecting data from said data structure and displaying said selected data as indicia or said indicator at said video display to define at least one base game outcome; and
if the base game outcome defines one of a predetermined schedule of winning base game outcomes, issuing a base game award to the player and if said feature indicator is selected and displayed, said processor configured to select a feature outcome corresponding to an outcome for a separate feature game.

2- The method of claim 1 comprising configuring the display as a game matrix and configuring said processor to control said display to display said selected indicia or feature indicator in coordinates of said matrix.

3- The method of claim 2 comprising configuring at least one of said processor and display to restrict display of said feature indicator to a predetermined location in said matrix.

4- The method of claim 1 comprising upon selection and display of said feature indicator randomly selecting a winning or losing outcome for the feature game.

5- The method of claim 4 comprising establishing at least one feature game winning outcome and if the randomly selected feature corresponding to the established feature game winning outcome, issuing an award to the player.

6- The method of claim 1 comprising enabling a plurality of feature games based upon the amount of said wager.

7- A method for players to play a plurality of gaming devices linked to a host processor, each gaming device having a display, a device processor, and a data input device, the method comprising:
for each gaming device providing a data structure storing data representing base game indicia and data representing at least one feature indicator;
at a gaming device the player making a wager to play the device and initiating play, said device processor in response to initiation of play randomly selecting data from said data structure and displaying said selected data as indicia or said indicator at said video display to define at least one base game outcome; and
if the base game outcome defines one or a predetermined schedule of winning base game outcomes, issuing a base game award to the player and if said feature indicator is selected and displayed, said processor configured to select a feature outcome;
comparing the selected feature outcome from any linked gaming device to at least one jackpot outcome and if a predetermined correspondence exists, issuing a jackpot to the player.

8- The method of claim 7 comprising said host processor comparing the selected feature outcome from any linked gaming device to at least one jackpot outcome and if a predetermined correspondence exists, issuing an award to the player.

9- The method of claim 7 comprising said device processor comparing determining any award at said device corresponding to said feature outcome.

10- A gaming device comprising:
a video display;
a device processor;
a data input device;
a data structure storing data representing base game indicia and data representing at least one feature indicator;
apparatus for the player to input a wager to play the device and initiate play, said device processor in response to initiation of play randomly selecting data from said data structure and displaying said selected data as indicia or said indicator at said video display to define at least one base game outcome; and
said processor configured to determine if the base game outcome defines one or a predetermined schedule of winning base game outcomes and if so issue a base game award to the player and if a feature indicator is selected and displayed, said device processor configured to select a feature outcome corresponding to an outcome for a separate feature game.

11- The device of claim 10 comprising said device processor configured to, in response to selection and display of a feature symbol randomly select a feature outcome and compare said selected feature outcome to a predetermined feature winning outcome and if said feature outcome corresponds to said predetermined winning feature outcome, issuing an award to the player.

12- A system including a plurality of electronic gaming devices comprising:
a host processor electronically connected to each gaming device of the system;
a device base game processor, a data structure storing data representing base game indicia and data representing at least one feature indicator;
for each device apparatus for the player to input a wager to play the device and initiate play, said device processor in response to initiation of play randomly selecting data from said data structure and displaying said selected data as indicia or said indicator at said video display to define at least one base game outcome for the device;
said device base game processor configured to determine if the base game outcome defines one or a predetermined schedule of winning base game outcomes and if so issue a base game award to the player and
at least one of said device base game processor or host processor configured to, in response to the selection and display of at least on feature indicator, select a winning or losing feature outcome.

13- The system of claim 12 comprising at least one of said host or device base game processor configured to randomly select a feature outcome and if said selected feature outcome corresponds to a predetermined at least one feature winning outcome, issue a feature award to the player.

14- A gaming device, comprising, in combination:
a display;
wagering means;
a processor operatively intercoupled between said wagering means and said display to activate said display upon receipt of a wager by said wagering means;
a base game having a plurality of outputs, at least one of which is recognized by a paytable, said outputs formed from a plurality of symbols defining indicia and shown on said display, and a paytable to be compared to said plurality of symbols; and
a concurrent game having means for dividing outputs of said primary game into regions, each said region having a target symbol, said target symbol defining a winning feature outcome adjacent its respective said region, and means for enabling at least a subset of one said region for concurrent game play, and said concurrent game further having special indicia defining feature outcomes wherein appearance of a plurality of said special indicia within an enabled region forces comparison of said target symbol and if said special indicia correlates to said target symbol, providing a winning result.

15- A method of gaming, the steps including:
displaying a R×C array formed from plural regions each having plural symbols;
enabling at least one said region to act in operative concert with said R×C array;
establishing a target adjacent said enabled region;
playing a game wherein said symbols are rearranged in said R×C array;
comparing said rearranged array with a paytable for potential awards upon matching said paytable with said rearranged array; and
comparing at least one output in said enabled region with said target.
